(19) United States
(12) Patent Application Publication
(10) Pub. No.: US 2017/0299116 A9
(43) Pub. Date: Oct. 19, 2017

(54) FIXTURE HANGER ASSEMBLY

(71) Applicant: Peter A. Vrame, Barrington Hills, IL (US)

(72) Inventor: Peter A. Vrame, Barrington Hills, IL (US)

(21) Appl. No.: 15/282,207

(22) Filed: Sep. 30, 2016

Related U.S. Application Data
(60) Provisional application No. 62/236,178, filed on Oct. 2, 2015.

(51) Int. Cl. F16M 13/02; B65D 75/00; B31B 2155/0012; B31B 70/61; B31B 2160/20; B31B 2170/20; B31B 70/644; B31B 70/262; B31B 70/18; B31B 2155/003; B31B 2155/00

(52) U.S. Cl. CPC F16M 13/027; B65D 75/008; B31B 2155/0012; B31B 70/61; B31B 2160/20; B31B 2155/00; B31B 70/644; B31B 70/262; B31B 70/18; B31B 2155/003; B31B 2170/20

(57) ABSTRACT

A fixture mounting assembly facilitates efficient and convenient mounting of lighting fixtures and like elements on various types of ceiling mounting components. In one embodiment, the mounting assembly in configured to readily adjustable in length, with the adjustable nature of the assembly facilitating versatile use by permitting convenient adjustment of the assembly to accommodate different, typically standardized spacing of the mounting components. In this embodiment, the assembly includes first and second, inner and outer channel members arranged in sliding, telescopic relationship. The channel members define and arrangement of openings and slots to facilitate fitment to different types of ceiling mounting components. The telescoping nature of the channel members facilitate their fitment to associated ceiling mounting components which may have different, standardized spacing. Efficient and versatile use desirably offers significant savings in time and installation costs for fixture installation. In alternative embodiment, a fixture hanger assembly includes a pair a substantially identical channel members configured for efficient fitment to so-called hard-lid/hat-rack ceiling components.

### CROSS-REFERENCE TO RELATED APPLICATIONS

This is a non-provisional application claiming priority to U.S. Provisional Ser. No. 62/213,449, filed on Oct. 2, 2015, which is hereby incorporated by reference in its entirety.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The present invention relates generally to arrangements from mounting lighting fixtures and like components in a building or other structure, and more particularly to a fixture hanger assembly that facilitates efficient mounting of fixtures on various types of associates ceiling support components having varying dimensional configurations.

### BACKGROUND OF THE INVENTION

Many buildings and like structures require ceiling mounting of lighting fixtures and like components to provide the necessary interior lighting for the structure. To this end, a typical building includes an arrangement of ceiling components upon which the fixtures are mounted. Such components are frequently configured to facilitate mounting of ceiling tiles or like finishing materials within the structure.

As is known in the art, the ceiling components upon which lighting fixtures and the like are mounted can have varying configurations, including so-called “hard lid/hat track” elements, “L-metal” elements, and “T-bar” elements. These components having mounting surfaces and shapes which differ from one to the other, with associated fixture hangers typically configured for fitment to the components. Lighting fixtures and like elements are, in turn, mounted on the hangers to facilitate the desired ceiling mounting of the fixtures.

As will be appreciated, some buildings may require mounting of dozens, or even hundreds, of lighting fixtures or the like. It is therefore desirable to provide fixture mounting arrangements with can be easily and efficiently fitted to the support components in the ceilings of the building, recognizing that the types of support components, and their relative spacing can vary from application to another.

The present invention in directed to an improved, hanger assembly which facilitates mounting of lighting fixtures or the like on different types of ceiling mounting components, with one embodiment being adjustable in nature to facilitate efficient use in which the spacing between associated mounting components can vary.

### SUMMARY OF THE INVENTION

In accordance with the present invention, a fixture hanger assembly facilitates efficient and convenient mounting of lighting fixtures and like elements on various types of ceiling mounting components. In one embodiment, the assembly is adjustable in nature to facilitate versatile use by permitting convenient adjustment of the assembly to accommodate different, typically standardized spacing of the mounting components. In an alternative embodiment, the assembly is configured for fixed-length mounting of fixtures on so-called hard lid/hat rack ceiling components. Considering that many buildings require installation of dozens or hundreds of lighting fixtures, the present mounting assembly can offer significant saving in time and installation costs.

In accordance with the first illustrated embodiment, the present hanger assembly includes a first, outer female channel member having a vertical web portion, and upper and lower return portions respectively extending from upper and lower margins of the web portion thereof.

The present hanger assembly further includes a second, inner male channel member having a vertical web portion, and upper and lower return portions respectively extending from upper and lower margins of the web portion thereof.

Notably, adjustability of the mounting assembly is provided by configuring the second, male channel member for fitment in sliding, telescopic relationship generally within the first, female channel to thereby form the hanger assembly. Relative sliding movement of the first and second channel members permits the desired adjustment of the length of the hanger assembly as may be required for various, center-to-center spacing of the ceiling mounting components.

Ordinarily, the telescopic channel members of the present hanger assembly are used in pairs, that is first and second ones of the cooperating, telescopic channel members are positioned in spaced apart relationship on the associated ceiling mounting components, and the associated lighting fixture or the like mounted to extent between the pair of telescopic channel members.

In order to permit fitment of the present adjustable assembly to associated ceiling mounting components, each of the first and second channel members defines a pair of end openings at respective ends thereof. Each of the end openings extends downwardly from the respective web portion and through the respective lower return portion for receiving an associated structural support element therein.

In the preferred form, each end opening includes an upper margin, with each end opening defining a notch in the respective web portion extending upwardly from the upper margin of the opening. By this configuration, each of the end openings can receive either a so-called T-bar mounting component, or a L-metal mounting component therein, thus facilitating versatile use of the present mounting assembly by positioning the mounting assembly to extend between an associated pair of the ceiling mounting components.

In accordance with this illustrated embodiment, each of end the openings in the first and second channel members is spaced from a respective end the channel member. This arrangement provides a deformable tab positioned adjacent to each of the end openings. After fitment to associated ceiling components, the deformable tabs can be manually bent and deformed, thereby desirably acting to secure the channel members to the associated ceiling components.

Versatility of use is further facilitated by configuring each of the first and second channel members to define a pair of slots at respective ends thereof. These slots extending inwardly from the respective end of each channel member, at the juncture of the respective web portion and the respective upper return portion. Notably, these slots facilitate fitment of present mounting assembly to so-called hard lid/hat track ceiling mounting components.

In this form of the present hanger assembly, each of the first and second channel members defines a pair of fastener openings in the upper return portion thereof. The fastener openings are respectively positioned adjacent to the pair of slots defined by each of the inner and outer channel members, and permit a suitable mechanical fastener to be inserted through the opening and into the associated ceiling mounting components of secure the hanger assembly, and thus the associated fixture, in position on the ceiling mounting components.

Versatile use of the present hanger assembly is further facilitated by the optional provision of a plurality of spaced apart fastener openings positioned generally along a longitudinal centerline of the web portion of each channel member. This permits insertion of suitable mechanical fasteners through the inner and outer channel members to lock them together against telescopic movement. These openings also permit other components or fixtures to be readily attached to the hanger assembly.

As noted the inner and outer channel members of the present hanger assembly are configured for relative, telescopic sliding movement. In order to maintain the channel members in the desired telescopic orientation, the upper and lower return portions of the first, outer female channel member define retention edges which respectively engage and retain the upper and lower return portions of the second, inner male channel member. The inner channel member is thus maintained in a nested, sliding relationship generally within the outer channel member.

In alternative embodiment, a fixture hanger assembly includes a pair a substantially identical channel members configured for efficient fitment to so-called hard-lid/hat track ceiling components. This embodiment of the hanger assembly comprises first and second channel members positionable in spaced apart relationship for mounting an associated fixture therebetween.

Each of the channel members has a vertical web portion, and upper and lower return portions respectively extending from upper and lower margins of the vertical web portion thereof. To facilitate efficient fitment to associated ceiling mounting components, each of the first and second channel members, like the channel members of the previous embodiment, defines a pair of slots at respective ends thereof, with the slots each extending inwardly from the respective end at the juncture of the respective web portion and the respective upper return portion.

Like the previous embodiment, each of said first and second channel members further defines a pair of fastener openings in the upper return portion thereof respectively positioned adjacent to the pair of slots defined by each of the channel members. As will be appreciated, this embodiment of the invention provides a fixed-length hanger assembly, including a pair of the substantially identical channel members, which can be very efficiently mounted on so-called hard lid/hat track ceiling mounting components.

Other features and advantages of the present invention will become readily apparent from following detailed description, the accompanying drawings, and the appended claims.

### BRIEF DESCRIPTION OF THE DRAWINGS

FIG. 1 is a perspective view of a first embodiment of a fixture mounting assembly in accordance with the present invention showing installation of a fixture on the ceiling mounting components of a building;

FIG. 2 is a perspective view of the mounting assembly of the embodiment of the present invention;

FIG. 3 is a relatively enlarged, perspective view of an end portion of a channel member of the present mounting assembly;

FIG. 4 is a cross-sectional view of inner and outer, female and male channel members of the present mounting assembly;

FIG. 5 is a perspective illustrating fitment of a channel member of the present mounting assembly to an associated ceiling mounting component.

FIG. 6 is a view similar to FIG. 3 illustrating the configuration of an alternative embodiment of the present fixture hanger assembly, wherein a pair of substantially identical channel members are positioned in spaced relationship to extend between a pair of associated ceiling mounting components;

FIG. 7 is a diagrammatic view further illustrating the alternative embodiment in use in connection with so-call hard lid/hat track ceiling mounting components;

FIG. 8 is a front elevational view of one of the channel members shown in FIG. 6;

FIG. 9 is a side elevational view thereof, the opposite side elevational view being a substantial mirror image;

FIG. 10 is top plan view thereof; and

FIG. 11 is a rear elevational view thereof.

### DETAILED DESCRIPTION OF THE PREFERRED EMBODIMENT

While the present invention is susceptible of embodiment in various forms, there is shown in the drawings, and will hereinafter be described, presently preferred embodiments, with the understanding that the present disclosure is to be considered as an exemplification of the invention, and not intended to limit the invention to the specific embodiments illustrated.

In accordance with the present invention, a fixture mounting assembly facilitates efficient and convenient mounting of lighting fixtures and like elements on various types of ceiling mounting components. In a first embodiment, the hanger assembly is adjustable in length, with the adjustable nature of the assembly facilitating versatile use by permitting convenient adjustment of the assembly to accommodate different, typically standardized spacing of the mounting components. Considering that many buildings require installation of dozens or hundreds of lighting fixtures, the present mounting assembly can offer significant saving in time and installation costs.

In an alternative embodiment, the present hanger assembly has been configured for non-adjustable, fixed spacing between associated ceiling mounting components, with this embodiment comprising a pair of substantially identical channel members particularly configured for use in association with so-called hard lid/hat track ceiling mounting components.

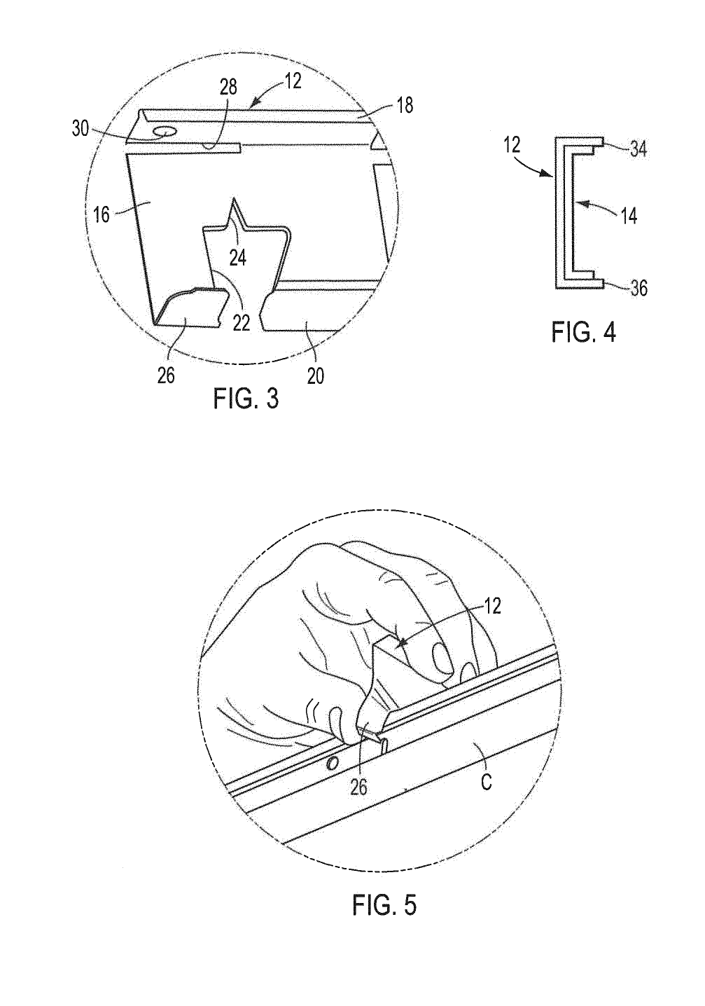

With reference first to FIGS. 1-5 showing the first embodiment of the present invention, the present mounting assembly includes telescopic channels member which facilitate adjustment of the length of the fixture hanger to accommodate use with ceiling components having differing spacing. In this embodiment, the adjustable hanger assemblies 10 each comprise a pair of telescopic channels, and are used in pairs 10, 10 to extend between ceiling mounting components C shown in FIG. 1, with an associated fixture F mounted to extend between and from the spaced pair of telescopic channel members.

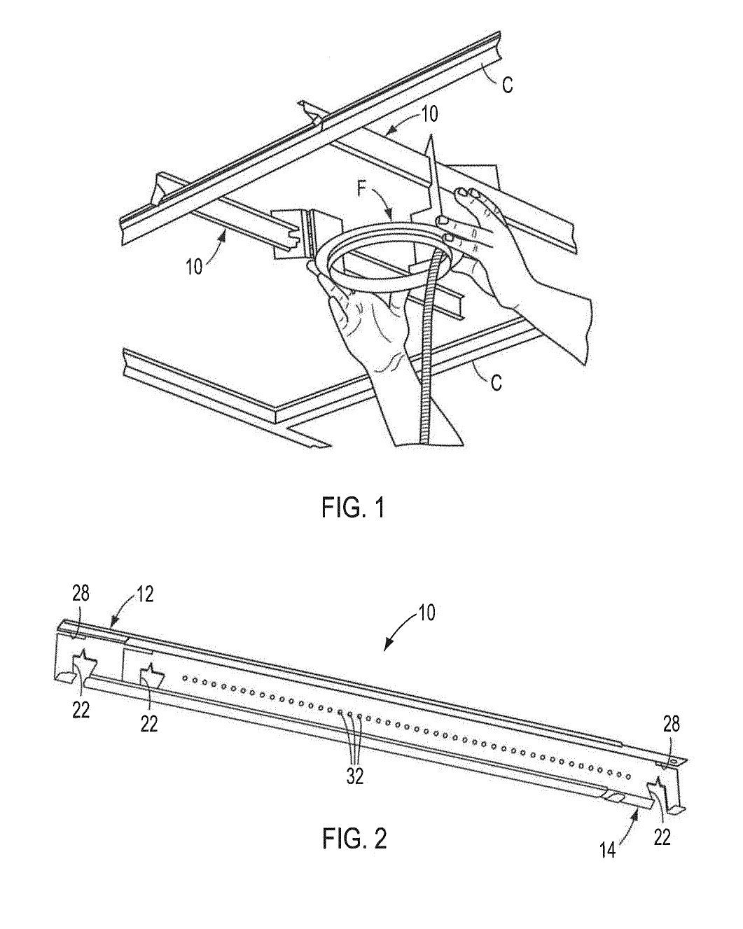

As shown in FIG. 2, each telescopic pair 10 of channel members includes a first, outer female channel member 12 and a second, inner male channel member 14. The channel members are configured to nest generally within each other, in sliding, telescopic relationship.

The first, outer female channel member 12 includes a vertical web portion 16, and upper and lower return portions 18, 20 respectively extending from upper and lower margins of the web portion 12 thereof.

Similarly, the second, inner male channel member 14 has a vertical web portion, and upper and lower return portions respectively extending from upper and lower margins of the web portion thereof. The configuration and features of inner channel member 14 are like those of the outer channel member 12, except as noted hereinafter, but with the understanding that inner channel member 14 is sized to nest and telescope within the outer channel member 12

Notably, adjustability of the mounting assembly 10 is providing by configuring the second, male channel member 14 for fitment in sliding, telescopic relationship generally within the first, female channel member 12 to thereby form the adjustable mounting assembly. Relative sliding movement of the first and second channel members permits the desired adjustment of the length of the mounting assembly.

In order to permit fitment of the present adjustable assembly to associated ceiling mounting components, each of the first and second channel members 12, 14 defines a pair of end openings 22 at respective ends thereof. Each of the end openings 22 extends downwardly from the respective vertical web portion 16, and through the respective lower return portion 20 for receiving an associated structural support element C therein.

In the preferred form, each end opening 22 includes an upper margin, with each end opening 22 defining a notch 24 in the respective web portion 16 extending upwardly from the upper margin of the opening. By this configuration, each of the end openings 22 can receive either a so-called T-bar mounting component, or a L-metal mounting component therein, thus facilitating versatile use of the present mounting assembly by positioning the mounting assembly to extend between an associated pair of the ceiling mounting components C.

In accordance with this illustrated embodiment, each of end openings 22 in the first and second channel members 12, 14 is spaced from a respective end the channel member. This arrangement provides a deformable tab 26 positioned adjacent to each of the end openings 22. After fitment to associated ceiling components C, the deformable tabs 36 can be manually bent and deformed, thereby desirably acting to securing the channel members to the associated ceiling components C.

Versatility of use is further facilitated by configuring each of the first and second channel members 12, 14 to define a pair of slots 28 at respective ends thereof. These slots 28 extend inwardly from the respective end of each channel member, at the juncture of the respective vertical web portion 16 and the respective upper return portion 18. Notably, these slots 28 facilitate fitment of present mounting assembly to so-called hard hat/hat track ceiling mounting components C.

In the preferred form of this embodiment of the present mounting assembly, each of the first and second channel members 12, 14 defines a pair of fastener openings 30 in the upper return portion thereof. The fastener openings 30 are respectively positioned adjacent to the pair of slots 28 defined by each of the inner and outer channel members 12, 14, and permit a suitable mechanical fastener to be inserted through the opening 30 and into the associated ceiling mounting components C to secure the mounting assembly 10, and thus the associated fixture, in position on the ceiling mounting components C.

Versatile use of the present mounting assembly is further facilitated by the optional provision of a plurality of spaced apart fastener openings 32 positioned generally along a longitudinal centerline of the web portion of each channel member 12, 14. This permits insertion of suitable mechanical fasteners through the inner and outer channel members to lock them together against telescopic movement. These openings 32 also permit other components or fixtures to be readily attached to the mounting assembly.

As noted, the inner and outer channel members 12, 14 of the present mounting assembly are configured for relative, telescopic sliding movement. In order to maintain the channel members in the desired telescopic orientation, the upper and lower return portions of the first, outer female channel member 12 define retention edges 34, 36 (see FIG. 4) which respectively engage and retain the upper and lower return portions of the second, inner male channel member. The inner channel member 14 is thus maintained in a nested, sliding relationship generally within the outer channel member 12.

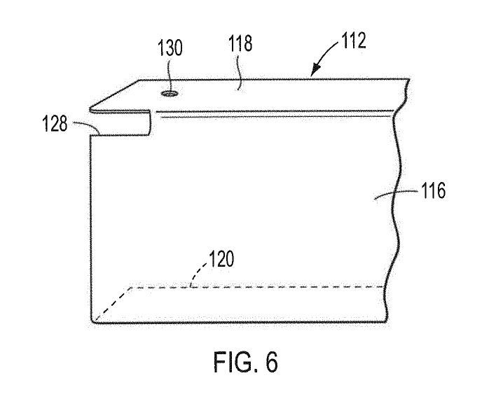

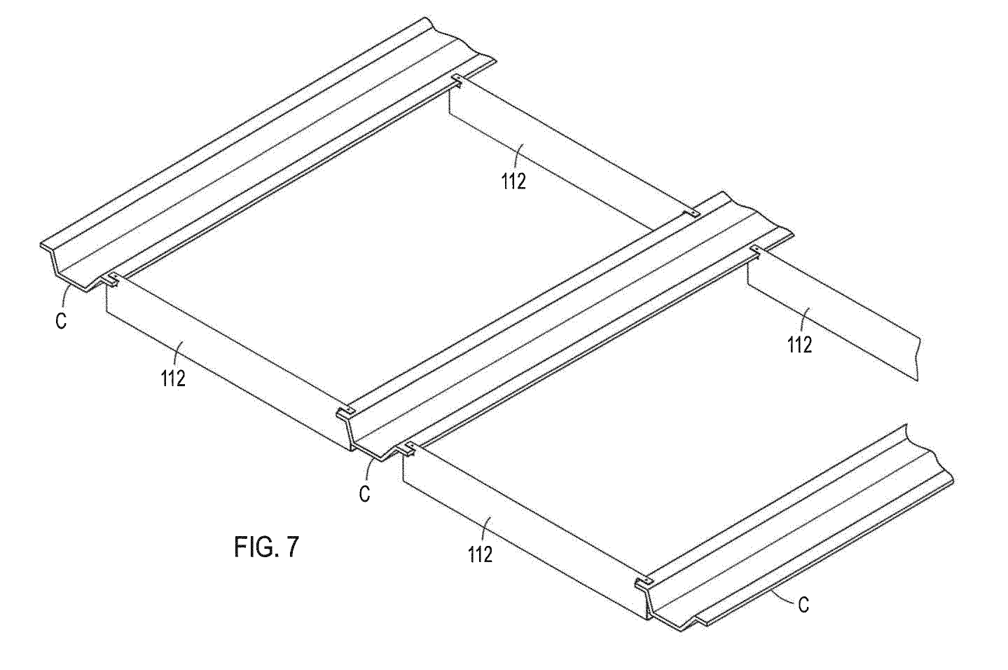

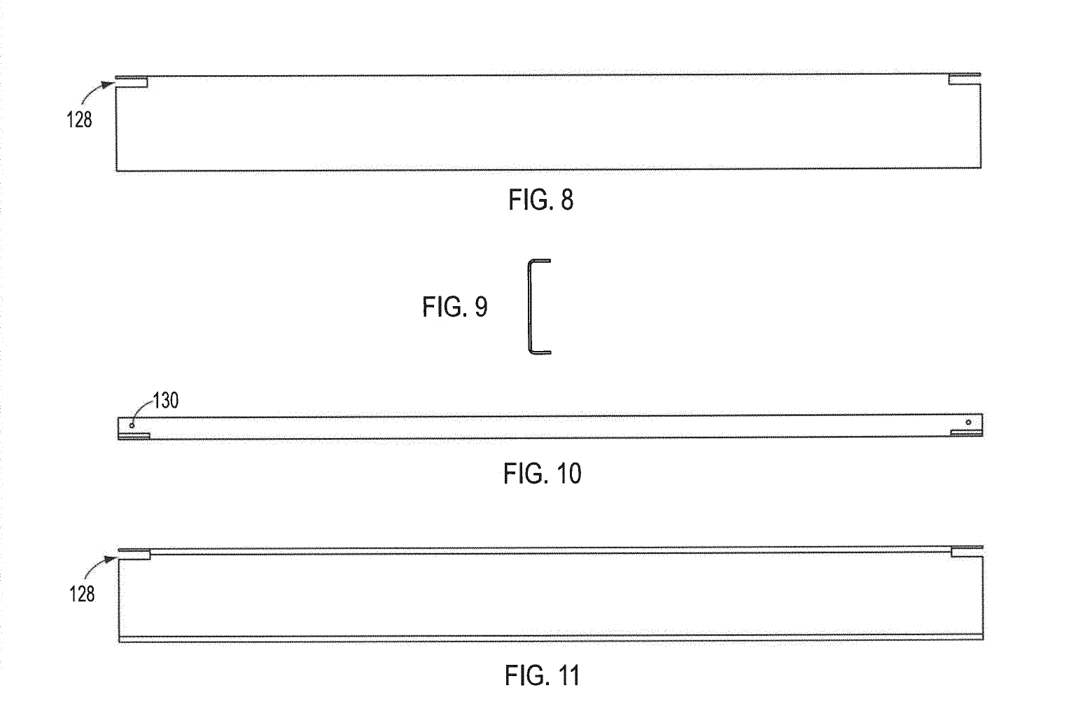

With reference now to FIGS. 6 and 7, in alternative embodiment of the present fixture hanger assembly is illustrated. In this embodiment, the assembly includes a pair of substantially identical channel members, designated 112, configured for efficient fitment to so-called hard-lid/hat-rack ceiling components C. The pair of channels members 112 can be configured generally like channel members 12, 14 of the previous embodiment, with the channel members 112 of this embodiment intended to be used in spaced apart relationship as shown in FIGURE in connection with hanger assemblies 10, 10.

In the alternative embodiment, a fixture hanger assembly includes a pair of substantially identical channel members 112 configured for efficient fitment to so-called hard lid/hat rack ceiling components. This embodiment of the hanger assembly comprises first and second channel members 112 positionable in spaced apart relationship for mounting an associated fixture therebetween.

Each of the channel members 112 has a vertical web portion 116, and upper and lower return portions 118, 120 respectively extending from upper and lower margins of the vertical web portion 116 thereof. To facilitate efficient fitment to associated ceiling mounting components, each of the first and second channel members 112 defines a pair of slots 128 at respective ends thereof (one being shown in the fragmentary view of FIG. 6). The slots 128 each extend inwardly from the respective end at the juncture of the respective vertical web portion 116 and the respective upper return portion 118.

Like the previous embodiment, each of said first and second channel members 112 further defines a pair of fastener openings 130 in the upper return portion 118 thereof, respectively positioned adjacent to the pair of slots 128 defined by each of the channel members.

As will be appreciated, this embodiment of the invention provides a fixed-length hanger assembly, comprising a pair of substantially identical ones of the channel members 116, which can be very efficiently mounted on so-called hard lid-hat rack ceiling mounting components C, as shown diagrammatically in FIG. 7.

From the foregoing, it will be observed that numerous modifications and variations can be effected without departing from the true spirit and scope of the novel concept of the present invention. It is to be understood that no limitations with respect to the specific embodiments disclosed herein are intended or should be inferred. The disclosure is intended to cover, by the appended claims, all such modifications as fall within the scope of the claims.

1. An adjustable fixture mounting assembly, comprising:
a first, outer female channel member having a vertical web portion, and upper and lower return portions respectively extending from upper and lower margins of said web portion thereof; and
a second, inner male channel member having a vertical web portion, and upper and lower return portions respectively extending from upper and lower margins of said web portion thereof,
said second, male channel member fitting in sliding, telescopic relationship generally within said first, female channel to form said adjustable mounting assembly, whereby relative sliding movement of said first and second channel members permit adjustment of the length of the mounting assembly,
each of said first and second channel members defining a pair of openings at respective ends thereof, each of said openings extending downwardly from the respective web portion and through the respective lower return portion for receiving and associates structural support element therein,
each of said openings being spaced from a respective end of each said channel member to thereby define a deformable tab positioned adjacent to each of said openings,
each of said first and second members further defining a pair of slot at respective ends thereof extending inwardly from the respective end at the juncture of the respective web portion and the respective upper return portion.

2. An adjustable fixture mounting assembly in accordance with claim 1, wherein
each of said openings defined by each of said first and second channel members includes an upper margin defined by the respective web portion, each of said openings including a notch in the respective web portion extending upwardly from the upper margin of the opening.

3. An adjustable fixture mounting assembly in accordance with claim 1, wherein
each of said first and second channel members defines a pair of fastener openings in the upper return portion thereof respectively positioned adjacent to the pair of slots defined by each of said channel members.

4. An adjustable fixture mounting assembly in accordance with claim 1, wherein
the web portion of each of said first and second channel members defines a plurality of fastener openings positioned generally along a longitudinal centerline of the web portion.

5. An adjustable fixture mounting assembly in accordance with claim 1, wherein
said upper and lower return portions of said first, outer female channel member define retention edges which retain the upper and lower return portions of said second, inner male channel member to maintain said first and second channel members in telescopic relationship with each other.

6. A fixture mounting assembly, comprising:
first and second channel members positionable in spaced apart relationship for mounting an associated fixture therebetween,
each of said channel members having a vertical web portion, and upper and lower return portions respectively extending from upper and lower margins of said web portion thereof; and
each of said first and second channel members defining a pair of slots at respective ends thereof extending inwardly from the respective end at the juncture of the respective web portion and the respective upper return portion,
each of said first and second channel members further defining a pair of fastener openings in the upper return portion thereof respectively positioned adjacent to the pair of slots defined by each of said channel members.
